(19) United States
(12) Patent Application Publication
(10) Pub. No.: US 2017/0133894 A1
(43) Pub. Date: May 11, 2017

(54) Stator and BLDC Motor Having the Same

(71) Applicant: Johnson Electric S.A., Murten (CH)

(72) Inventors: Yong Bin LI, Hong Kong (CN); Long Shun JIANG, Shenzhen (CN); Xian Chun FAN, Shenzhen (CN); Ping WANG, Shenzhen (CN)

(21) Appl. No.: 15/348,191

(22) Filed: Nov. 10, 2016

(30) Foreign Application Priority Data
Nov. 10, 2015 (CN) 2015 1076 0759.4

(51) Int. Cl. H02K 1/16; H02K 3/34; H02K 1/27; H02K 3/12

(52) U.S. Cl. CPC H02K 1/165; H02K 3/12; H02K 3/34; H02K 1/2706

(57) ABSTRACT

A brushless direct current motor includes a stator and a rotor rotatable relative to the stator. The stator includes a plurality of segments arranged circumferentially and a support bracket connecting the segments together. Each segment includes a segment core unit and a winding assembly assembled on the segment core unit. The segment core units of two adjacent segments defining a gap there between. The support bracket is made of non-magnetic material.

### CROSS REFERENCE TO RELATED APPLICATIONS

This non-provisional patent application claims priority under 35 U.S.C. §119(a) from Patent Application No. 201510760759.4 filed in The People's Republic of China on 10 Nov. 2015.

### FIELD OF THE INVENTION

The present invention relates to a BLDC motor, and in particular to a stator and a BLDC motor having the same.

### BACKGROUND OF THE INVENTION

Brushless direct current (BLDC) motors typically include a stator winding and a permanent magnet rotor. The direction of the current in the stator winding is altered based on the position of the rotor, thus establishing an alternating magnetic field which drives the rotor to continuously rotate. The brushless direct current motors have long lifespan and low noise.

The existing BLDC motor overall is usually of a circular cylindrical structure. The stator includes an annular stator core and a plurality of teeth extending radially from the stator core. The teeth are arranged uniformly in a circumferential direction of the stator core. The winding is wound around the teeth. The rotor is received in the stator and opposed to the stator. However, the stator core is of a continuous annular structure, which causes a certain degree of magnetic leakage such that the magnetic flux and efficiency is reduced. On the other hand, the annular stator core also limits a slot opening between the teeth, which makes it inconvenient to wind the windings and results in a low slot fill factor.

### SUMMARY OF THE INVENTION

Thus, there is a desire for a stator and a motor having the same, which can effectively increase the slot fill factor and magnetic flux and hence the efficiency of the motor.

In one aspect, a stator is provided which includes a plurality of segments arranged circumferentially and a support bracket connecting the segments together. Each segment includes a segment core unit and a winding assembly assembled on the segment core unit. The segment core units of two adjacent segments defining a gap there between. The support bracket is made of non-magnetic material.

Preferably, the number of the segments is 3N, where N≧1.

Preferably, a portion of the support bracket is inserted into the gap between the segment core units of the two adjacent segments.

Preferably, the support bracket comprises an end plate and a plurality of connecting portions extending from the end plate, and each connecting portion is inserted into the gap between the segment core units of two adjacent segments.

Preferably, one of the connecting portion and the segment core unit forms a latching block, the other of the connecting portion and the segment core unit forms a latching slot, and the latching block is engaged in the latching slot to connect the adjacent segment core units together.

Preferably, each segment core unit forms an axial hole, the support bracket forms a plurality of mounting posts, and each mounting post is engaged in the axial hole of a respective segment core unit.

Preferably, the stator further includes another support bracket, the another support bracket comprises an end plate and a plurality of mounting posts extending from the end plate, and each mounting post is engaged in the axial hole of a respective segment core unit.

Preferably, the mounting posts of the another support bracket are respectively aligned with the mounting posts of the support bracket.

Preferably, a total length of the two aligned mounting posts of the support bracket and the another support bracket is not greater than an axial height of the segment core unit.

Preferably, the segment core unit is generally W-shaped, comprising two wing portions and an arm portion disposed between the two wing portions, the wing portions and the arm portion define an assembly space there between, and the winding assembly is attached around the arm portion and disposed in the assembly space.

Preferably, the support bracket forms a partition plate extending from the end plate, and the partition plate is inserted into the assembly space between the arm portion and a neighboring wing portion to isolate the winding assembly from the wing portion.

Preferably, each wing portion forms a latching block, the connecting portion forms corresponding latching slots, and the latching blocks of the adjacent wing portions of two neighboring segments are engaged in the latching slots of a corresponding connecting portion.

Preferably, the winding assembly comprises an insulating bracket and a winding wound around the insulating bracket, a central area of the insulating bracket forms an assembly hole corresponding to the arm portion, the winding assembly is mounted to the segment core unit with the arm portion of the segment core unit being inserted into the assembly hole of the insulating bracket.

In another aspect, another stator is provided which includes a plurality of segments arranged circumferentially and a support bracket connecting the segments together. Each segment includes a segment core unit and a winding assembly assembled on the segment core unit. Two adjacent segments are separated from each other by a portion of the support bracket.

In another aspect, a brushless direct current motor is provided which includes the above stator and a rotor rotatable relative to the stator.

### BRIEF DESCRIPTION OF THE DRAWINGS

FIG. 1 illustrates a brushless direct current motor according to one embodiment of the present invention.

FIG. 2 illustrates a stator of the motor of FIG. 1.

FIG. 3 is an exploded view of the stator of FIG. 2.

FIG. 4 is an exploded view of the stator, viewed from another aspect.

FIG. 5 illustrates an individual segment of the armature of the stator.

FIG. 6 is an exploded view of the armature segment of FIG. 5.

FIG. 7 is a cross sectional view of the stator.

FIG. 8 illustrates a rotor of the motor of FIG. 1.

FIG. 9 is a longitudinal cross sectional view of the rotor of FIG. 8.

FIG. 10 is a transverse cross-sectional view of the rotor of FIG. 8.

### DETAILED DESCRIPTION OF THE PREFERRED EMBODIMENTS

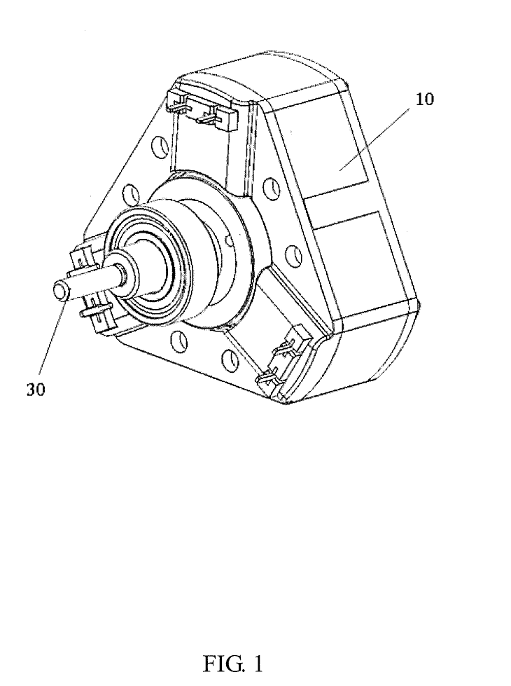

FIG. 1 illustrates a brushless direct current motor according to one embodiment of the present invention. The brushless direct current motor includes a stator 10, and a rotor 30 rotatable relative to the stator 10. In this embodiment, the motor is an inner-rotor motor, and the rotor 30 is rotatably mounted into the stator 10.

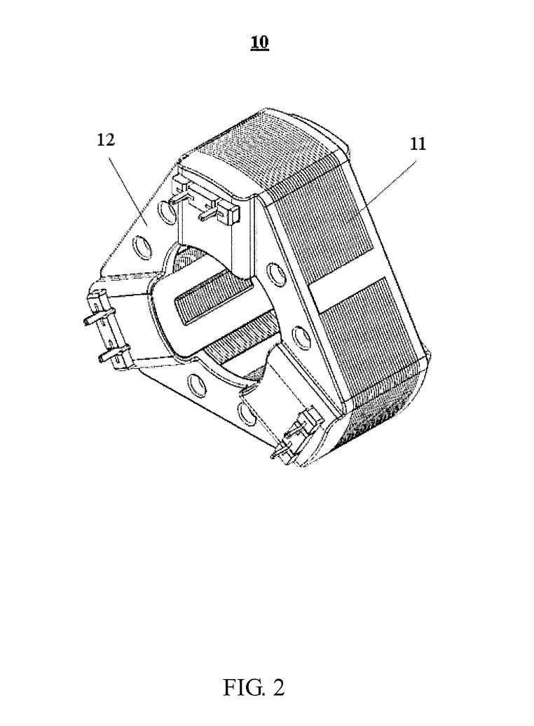

Referring to FIG. 2 to FIG. 4, the stator 10 includes an armature 11, and two support brackets 12 (hereinafter referred as upper support bracket 12a and lower support bracket 12b) disposed at two axial ends of the armature 11. The armature 11 is of a segmented structure including a plurality of segments 13. The number of the segments 13 is 3N, wherein N is an integer equal or greater than 1, i.e., N≧1. Preferably, the segments 13 of the armature 11 are substantially of the same structure and evenly arranged along a circumferential direction. Adjacent segments 13 define a gap 14 there between, i.e. the segments 13 are discontinuously arranged in the circumferential direction. In this embodiment, the armature 11 includes three segments 13 and the overall outer shape of the armature 11 is generally a triangle. A circular through hole 15 is cooperatively defined by the three segments 13, and the rotor 30 is received in the through hole 15. As such, the overall outer shape of the assembled motor is substantially triangle-shaped.

In an alternative embodiment, based on the number of the segments 13, the outer shape of the motor/armature 11 is substantially a polygon with 3N sides. For example, six segments 13 form a motor/armature 11 in the shape of a hexagon, and nine segments 13 form a motor/armature 11 in the shape of an enneagon. In comparison with the traditional round or square motor, the motor/armature 11 in the shape of a polygon with 3N sides can remove excessive core portions, which reduces the weight and size of the motor/armature 11 and hence satisfies user's special requirements for mounting space.

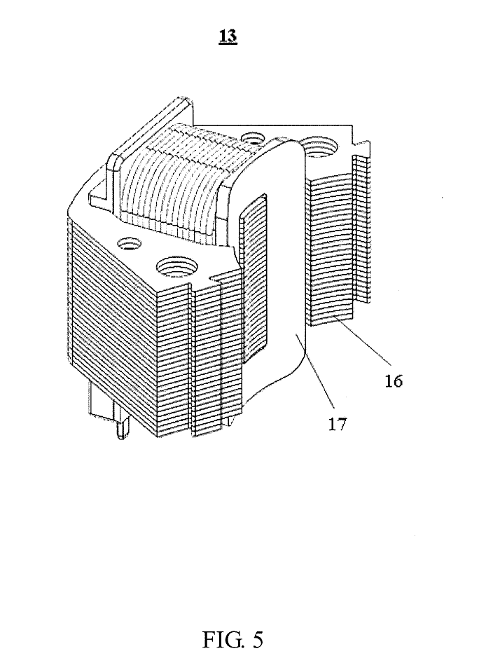

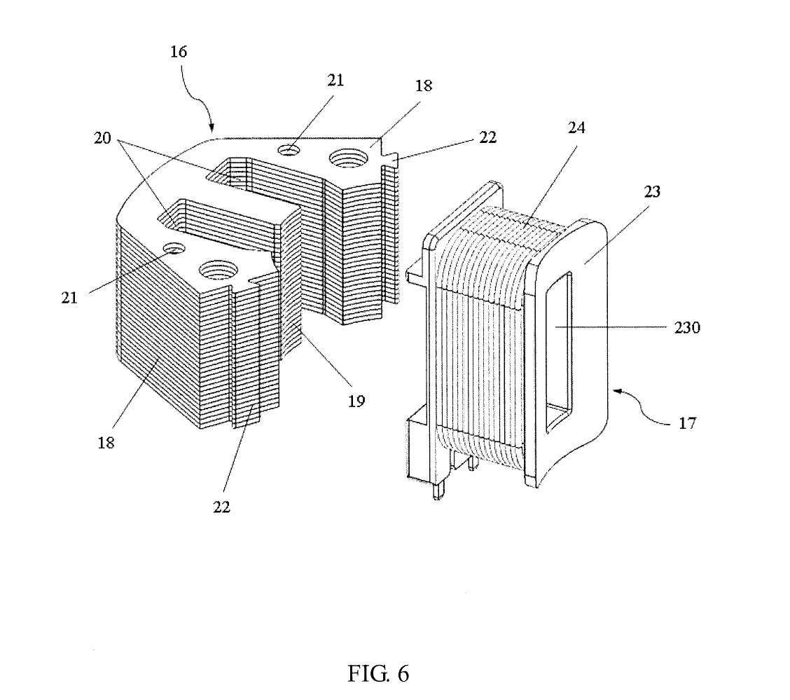

Referring to FIG. 5 and FIG. 6, each segment 13 of the armature 11 includes a segment core unit 16 and a winding assembly 17 wound around the segment core unit 16. The segment core unit 16 is formed by stacking a plurality of core laminations such as silicon steel laminations. The segment core unit 16 overall is in the shape of W, including two wing portions 18 and an arm portion 19 disposed between the two wing portions 18. Radial outer ends of the wing portions 18 and the arm portion 19, i.e. the ends at a radial outer side of the stator 10, are connected together. Radial inner ends of the wing portions 18 and the arm portion 19, i.e. the ends facing the rotor 30, are separated apart from each other. Each wing portion 18 and the arm portion 19 form an assembling space 20 there between, for mounting the winding assembly 17.

Preferably, each wing portion 18 forms a through hole 21 that axially passes through the wing portion 18. The radial inner end of each wing portion 18 protrudes radially inwardly to form a latching block 22 for mounting with the support bracket 12. The winding assembly 17 includes an insulating bracket 23 and a winding 24 wound around the insulating bracket 23. Preferably, the insulating bracket 23 is made of insulating plastic. An electrically conductive pin is fixedly inserted in the insulating bracket 23. The winding 24 is wound on the insulating bracket 23 and electrically connected with the electrically conductive pin. The winding assembly 17 is attached around the arm portion 19 of the segment core unit 16. A central area of the insulating bracket 23 defines an assembly hole 230 corresponding to the arm portion 19.

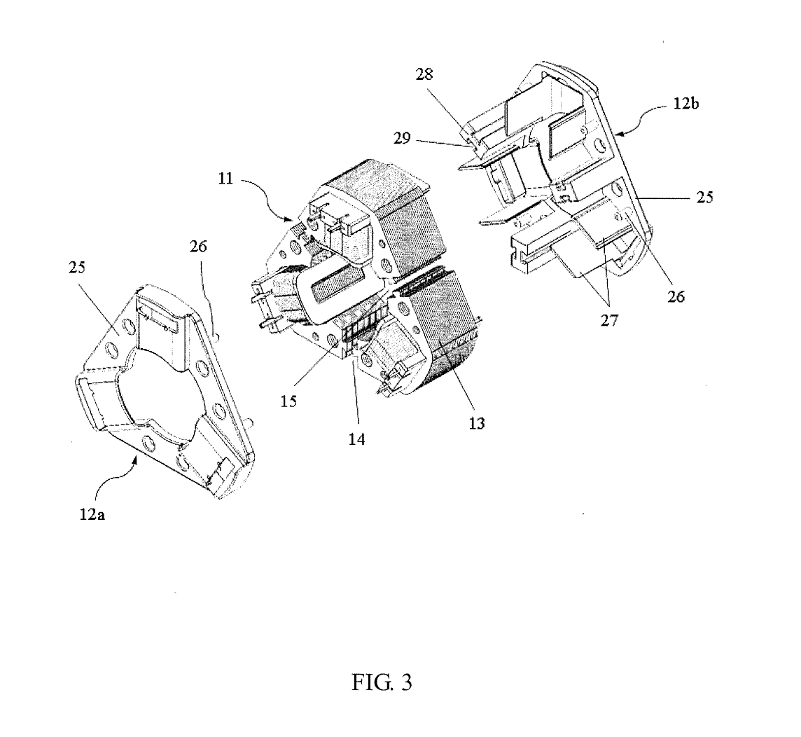

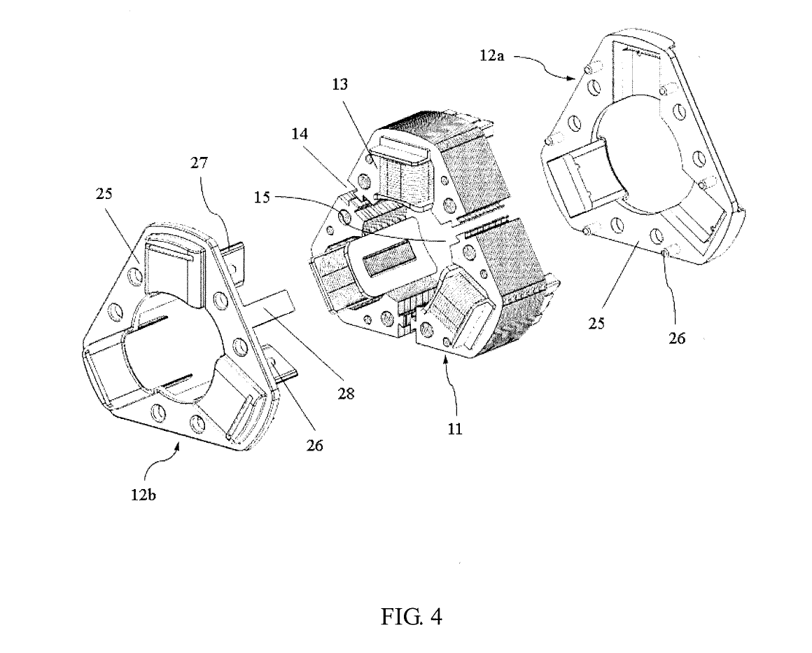

The support bracket 12, made of a non-magnetic material such as insulating plastic, connects the segments 13 of the armature 11 together, with the segment core units 16 of the respective segments 13 separated to reduce magnetic leakage. Referring also to FIG. 3 and FIG. 4, the upper support bracket 12a and the lower support bracket 12b are similar in construction, both including an end plate 25 and a plurality of mounting posts 26 extending perpendicularly from the end plate 25. The end plates 25 are sheets covering two axial ends of the armature 11, respectively. Each end plate 25 has an outer shape and a size matching with the armature 11. For example, in this embodiment, each end plate 25 is substantially triangular, having an internal round hole. The mounting posts 26 of the upper and lower support brackets 12a, 12b are aligned with each other in the axial direction. A total length of each two aligned mounting posts 26 extending out of the end plates 25 is not greater than an axial height of the segment core unit 16. As such, after assembled, the aligned mounting posts 26 of the two support brackets 12a, 12b do not interfere with each other. The mounting posts 26 correspond to the through holes 21 of the wing portions 18 of the segment core unit 16. In assembly, each two axially aligned mounting posts 26 of the two support brackets 12a, 12b are inserted into one same through hole 21 from the two axial ends of the segment core unit 16, respectively, to position and support the segment core unit 16.

The lower support bracket 12b further forms two partition plates 27 corresponding to each segment 13. The two partition plates 27 extend perpendicularly from the end plate 25. The length of the partition plate 27 extending out of the end plate 25 is substantially equal to the axial height of the segment core unit 16. The lower support bracket 12b further forms a connecting portion 28 corresponding to each two adjacent segments 13. The connecting portion 28 extends perpendicularly from the end plate 25. The length of the connecting portion 28 extending out of the end plate 25 is substantially equal to the axial height of the segment core unit 16. Preferably, the connecting portion 28 has an H-shaped cross-section with two latching slots 29 formed at two sides thereof. Each latching slot 28 engagingly receives one corresponding latching block 22 of the wing portion 28 of the segment core unit 16 of one adjacent segment 13.

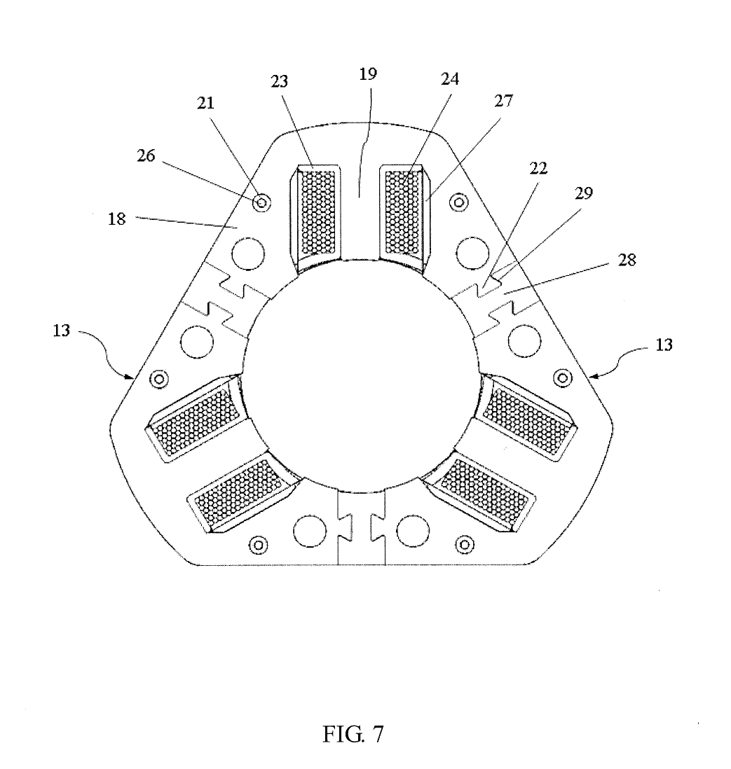

Referring also to FIG. 7, during assembly, each partition plate 27 is inserted into the space 20 between one wing portion 18 and the arm portion 19 of the segment core unit 16 and leans on the wing portion 18, thus isolating the windings 24 from the wing portion 18 of the segment core unit 16 to prevent the windings 24 from short circuit. Each connecting portion 28 is inserted into the gap 14 between the corresponding wing portions 18 of the segment core units 16 of the adjacent segments 13. The latching blocks 22 of the two wing portions 18 axially slide into the latching slots 29 of the connecting portion 28, respectively, which connects the adjacent segments 13 together to form the armature 11. Preferably, the latching block 22 form a dovetail shaped and the latching slot 29 has a shape matching the latching block, thus avoid disengagement there between. In an alternative embodiment, the latching block may also be of another shape such as rectangular or wedge shape, and the latching slot has a shape matching with the latching block, which can also result in a firm connection.

In this embodiment, the partition plates 27 are formed on the lower support bracket 12b to isolate the segment core units 16 from the windings 24, and the connecting portions 28 are formed to connect the segment core units 16. In another embodiments, the partition plates 27 may also be formed on the upper support bracket 12a, or both the upper and lower support brackets 12a, 12b are formed with the partition plates 27. The connecting portions 28 may be formed on the upper support bracket 12a, or both the upper and lower support brackets 12a, 12b are formed with the connecting portions 28. In addition, the connecting portions 28 and the partition plates 27 may be formed on the same support bracket 12a or 12b, or formed on the upper and lower bracket 12a and 12b, respectively.

Further, in this embodiment, the latching block 22 is formed on the wing portion 18 of the segment core unit 16, the latching slot 29 is formed on the connecting portion 28, and the latching block 22 is engaged in the latching slot 29 to connect two adjacent segments 13. In an alternative embodiment, the latching slot 29 may be fruited on the segment core unit 16, the connecting portion 28 is formed with the protruding latching block 22, and the adjacent segments 13 are likewise connected together through the locking connection between the latching block and the latching slot. This locking connection structure is also simple and convenient to operate.

During manufacturing of the stator 10, the winding 24 is first wound on the insulating bracket 23. The winding may be wound by using a concentrated winding method. After the winding is completed, the assembly hole 230 of the insulating bracket 23 is aligned with the arm portion 19 of the segment core unit 16, and the arm 19 of the segment core unit 16 is pressed into the assembly hole 230 of the insulating bracket 23, or the insulating bracket 23 is attached around the arm portion 19 to form an individual segment 13 of the armature 11. The upper and lower support brackets 12a, 12b are mounted to the two axial ends of the segments 13 to connect the segments 13 together to form the stator 10.

In the present invention, the winding 24 is wound on the insulating bracket 23 before the insulating bracket 23 is assembled to the segment core unit 16. Therefore, winding of the winding 24 is not subject to the limit of the shape and size of the slot opening and the winding process, which can effectively increase the slot fill factor of the winding 24 and the power density of the motor. In comparison with the windings directly wound on the integral segment core unit, the winding process and the assembly with the segment core unit after the winding process are simple, fast and highly efficient, which facilitates automation of the manufacturing process. In addition, the stator 10 is formed by multiple segments 13 connected together through the support bracket 12, and the segment core units 16 of the stator 10 are isolated by the non-magnetic connecting portions 28 in the circumferential direction. In comparison with the traditional integral stator design, the stator 10 of the present invention reduces the magnetic leakage on the magnetic path, which increases the motor performance by at least 10%.

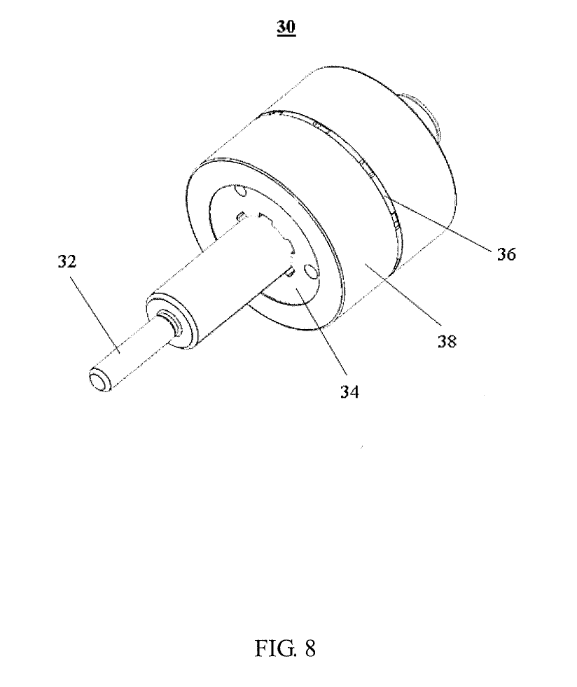

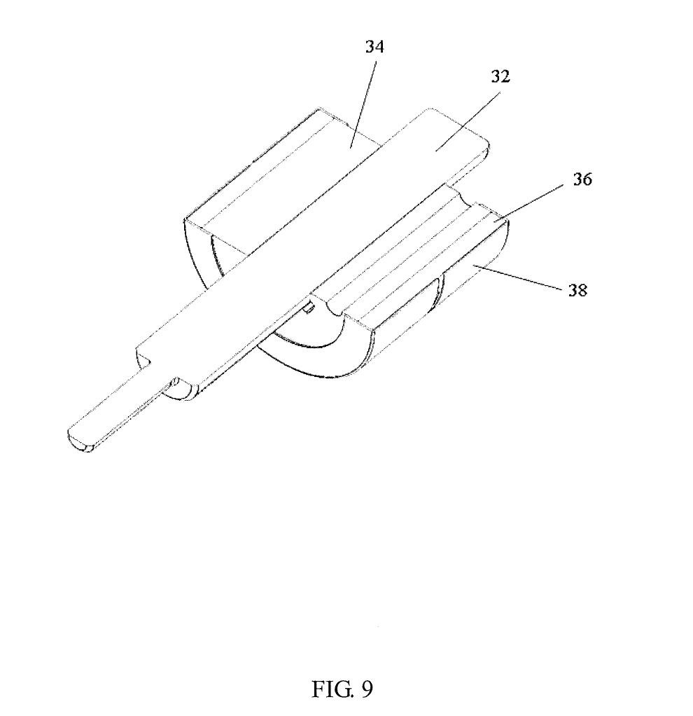

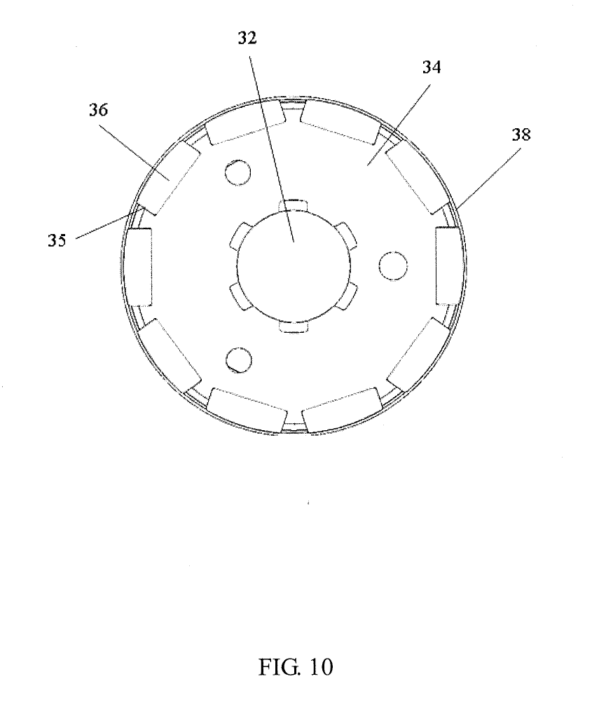

Referring to FIG. 8 to FIG. 10, the rotor 30 includes a rotary shaft 32, a rotor core 34 fixedly attached on the rotary shaft 32, a plurality of magnets 36 attached to the rotor core 34, and a rotor sleeve 38 surrounding the magnets 36. The rotor core 34 is generally cylindrical. A plurality of grooves 35 are formed in a radial outer surface of the rotor core 34. The grooves 35 are uniformly spaced along a circumferential direction. Each groove 35 passes through the rotor core 34 along an axial direction. In this embodiment, the number of the grooves 35 is ten. Each groove 35 receives one magnet 36 therein. The magnet 36 may be a ferrite magnet 36. The radial outer surface of the magnet 36 is arc-shaped, and the radial outer surfaces of all magnets 36 are substantially located on one same cylindrical surface. In this embodiment, the outer surface of the magnet 36 protrudes beyond the outer surface of the rotor core 34. There are two rotor sleeves 38 each being a cylindrical structure with one open end.

In assembly, the two rotor sleeves 38 are pressed onto the rotor core 34 from two axial ends thereof, respectively, radially surrounding the rotor core 34 and the magnets 36 to prevent the magnets from falling off during rotating of the rotor. In assembly, the rotor 30 is inserted into the through hole 15 of the stator 10, the stator 10 and rotor 30 are directly mounted to a user system. An mounting housing with flange for the mounting purpose are integrally formed with a mounting bracket of the user system by die-casting, which reduces the number of components and the assembly process thus reducing the material cost and assembly cost.

Although the invention is described with reference to one or more preferred embodiments, it should be appreciated by those skilled in the art that various modifications are possible. For example, while the armature is used as the stator in this embodiment, the armature may also be used as the rotor. Therefore, the scope of the invention is to be determined by reference to the claims that follow.

1. A stator for a motor, comprising:
a plurality of segments arranged circumferentially, each segment comprising a segment core unit and a winding assembly assembled on the segment core unit, the segment core units of two adjacent segments defining a gap there between; and
a non-magnetic support bracket connecting the segments together.

2. The stator of claim 1, wherein the number of the segments is 3N, where N≧1.

3. The stator of claim 1, wherein a portion of the support bracket is inserted into the gap between the segment core units of the two adjacent segments.

4. The stator of claim 2, wherein the support bracket comprises an end plate and a plurality of connecting portions extending from the end plate, and each connecting portion is inserted into the gap between the segment core units of two adjacent segments.

5. The stator of claim 4, wherein one of the connecting portion and the segment core unit forms a latching block, the other of the connecting portion and the segment core unit forms a latching slot, and the latching block is engaged in the latching slot to connect the adjacent segment core units together.

6. The stator of claim 4, wherein each segment core unit forms an axial hole, the support bracket forms a plurality of mounting posts, and each mounting post is engaged in the axial hole of a respective segment core unit.

7. The stator of claim 6, further comprising another support bracket, the another support bracket comprises an end plate and a plurality of mounting posts extending from the end plate, and each mounting post is engaged in the axial hole of a respective segment core unit.

8. The stator of claim 7, wherein the mounting posts of the another support bracket are respectively aligned with the mounting posts of the support bracket.

9. The stator of claim 8, wherein a total length of the two aligned mounting posts of the support bracket and the another support bracket is not greater than an axial height of the segment core unit.

10. The stator of claim 4, wherein the segment core unit is generally W-shaped, comprising two wing portions and an arm portion disposed between the two wing portions, the wing portions and the arm portion define an assembly space there between, and the winding assembly is attached around the arm portion and disposed in the assembly space.

11. The stator of claim 10, wherein the support bracket forms a partition plate extending from the end plate, and the partition plate is inserted into the assembly space between the arm portion and a neighboring wing portion to isolate the winding assembly from the wing portion.

12. The stator of claim 10, wherein each wing portion forms a latching block, the connecting portion forms corresponding latching slots, and the latching blocks of the adjacent wing portions of two neighboring segments are engaged in the latching slots of a corresponding connecting portion.

13. The stator of claim 10, wherein the winding assembly comprises an insulating bracket and a winding wound around the insulating bracket, a central area of the insulating bracket forms an assembly hole corresponding to the arm portion, the winding assembly is mounted to the segment core unit with the arm portion of the segment core unit being inserted into the assembly hole of the insulating bracket.

14. A brushless direct current motor comprising a stator according to claim 1 and a rotor rotatable relative to the stator.

15. A stator for a motor, comprising:
a plurality of segments arranged circumferentially, each segment comprising a segment core unit and a winding assembly assembled on the segment core unit; and
a support bracket connecting the segments together,
wherein two adjacent segments are separated from each other by a portion of the support bracket.

16. The stator of claim 15, wherein the support bracket comprises a plurality of mounting post, each segment core unit defines a through hole therein, and each mounting post is engaged in the through hole of a respective segment core unit.

17. The stator of claim 15, wherein the portion of the support bracket and the segment core unit are connected together by a latching mechanism, and the latching mechanism comprises a latching slot and a latching block engagable with the latching slot.

18. The armature of claim 15, wherein the segment core unit is substantially W-shaped, comprising two wing portions and an arm portion disposed between the two wing portions, the wing portions and the arm portion define an assembly space there between, and the winding assembly is attached around the arm portion and located in the assembly space.

19. The armature of claim 18, wherein the support bracket comprises a partition plate inserting into the assembly space between the arm portion and an adjacent wing portion to isolate the winding assembly from the wing portion.

20. A brushless direct current motor comprising a stator according to claim 15 and a rotor rotatable relative to the stator.
